(19) United States
(12) Patent Application Publication
(10) Pub. No.: US 2018/0264737 A1
(43) Pub. Date: Sep. 20, 2018

(54) DETERMINING LAYER THICKNESS

(71) Applicant: Hewlett-Packard Development Company, L.P., Houston, TX (US)

(72) Inventors: Sergio Puigardeu Aramendia, Barcelona (ES); Carmen Blasco Cortes, Barcelona (ES); Alejandro Manuel De Pena, Sant Cugat del Valles (ES)

(21) Appl. No.: 15/760,934

(22) PCT Filed: Jan. 19, 2016
(86) PCT No.: PCT/EP2016/050942

§ 371 Date: Mar. 16, 2018

(51) Int. Cl. B29C 64/393; B33Y 50/02; B33Y 10/00; B33Y 30/00; B28B 1/00; B29C 64/153; B28B 17/00; B22F 3/105; C03B 19/01

(52) U.S. Cl. CPC B29C 64/393; B33Y 50/02; B33Y 10/00; B33Y 30/00; B28B 1/001; B22F 2003/1057; B28B 17/0072; B28B 17/0081; B22F 3/1055; C03B 19/01; B29C 64/153

(57) ABSTRACT

According to one example, there is provided a method, in a three-dimensional printing system (100), of determining the thickness of a layer of build material formed on a build platform (104). The method comprises forming a layer of build material (402) on a base having predetermined color characteristics, measuring color characteristics of the deposited layer of build material, and determining, based on the measured color characteristics, the thickness of at least a portion of the formed layer of build material.

### BACKGROUND

Additive manufacturing techniques, such as three-dimensional (3D) printing, enable objects to be generated on a layer-by-layer basis. Some 3D printing techniques may generate layers of an object by forming successive layers of a build material on a build platform, and selectively solidifying portions of each layer of the build material.

### BRIEF DESCRIPTION

Examples will now be described, by way of non-limiting example only, with reference to the accompanying drawings, in which:

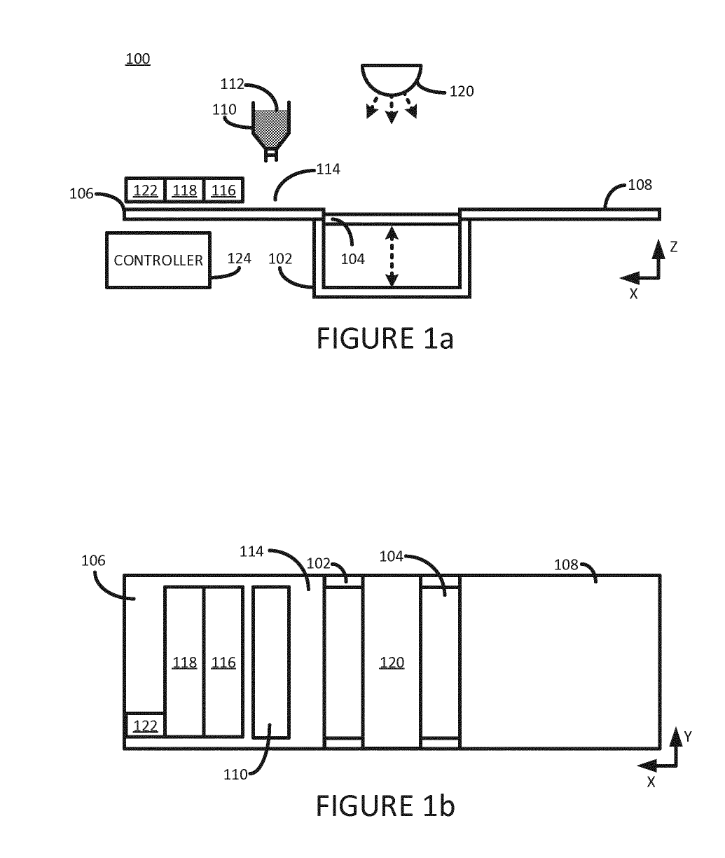

FIG. 1a is a simplified side view illustration of a three-dimensional printing system according to one example;

FIG. 1b is a simplified top view illustration of a three-dimensional printing system according to one example;

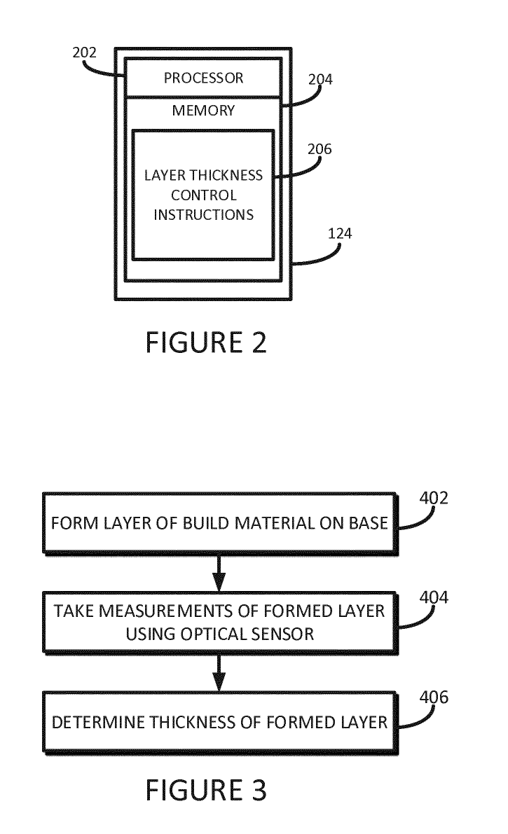

FIG. 2 is a block diagram of a controller according to one example;

FIG. 3 is a flow diagram outlining an example method according to one example;

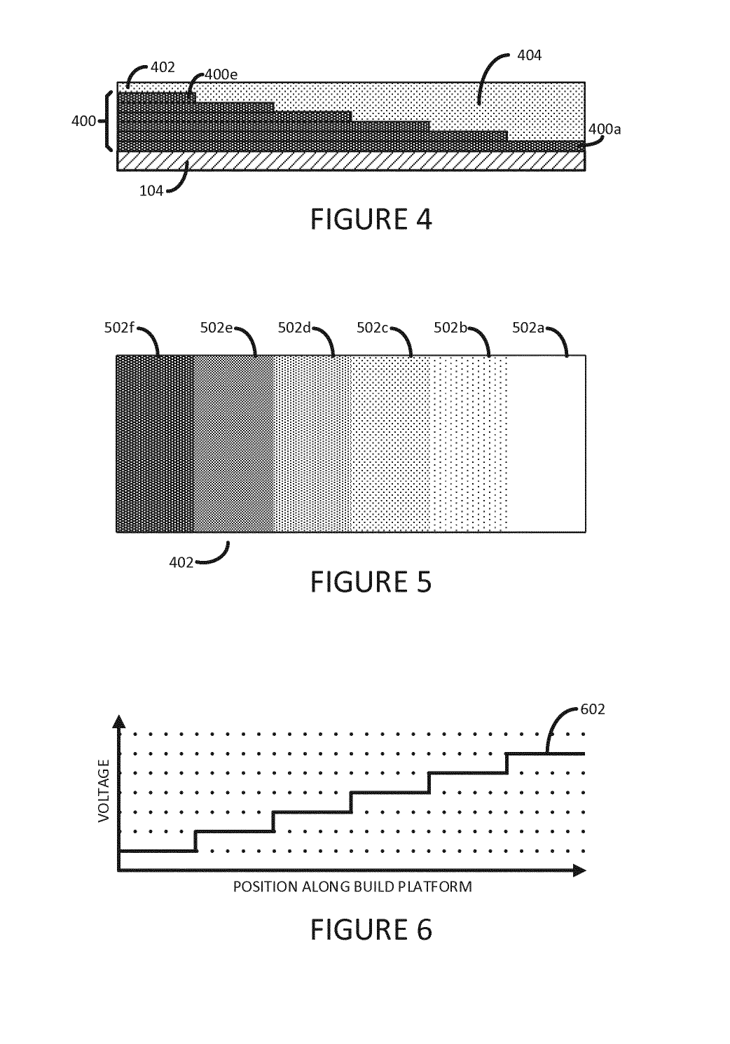

FIG. 4 is a side view illustration of a set of layers of build material according to one example;

FIG. 5 is a top view illustration of a layer of build material;

FIG. 6 is a graph showing an electrical signal according to one example;

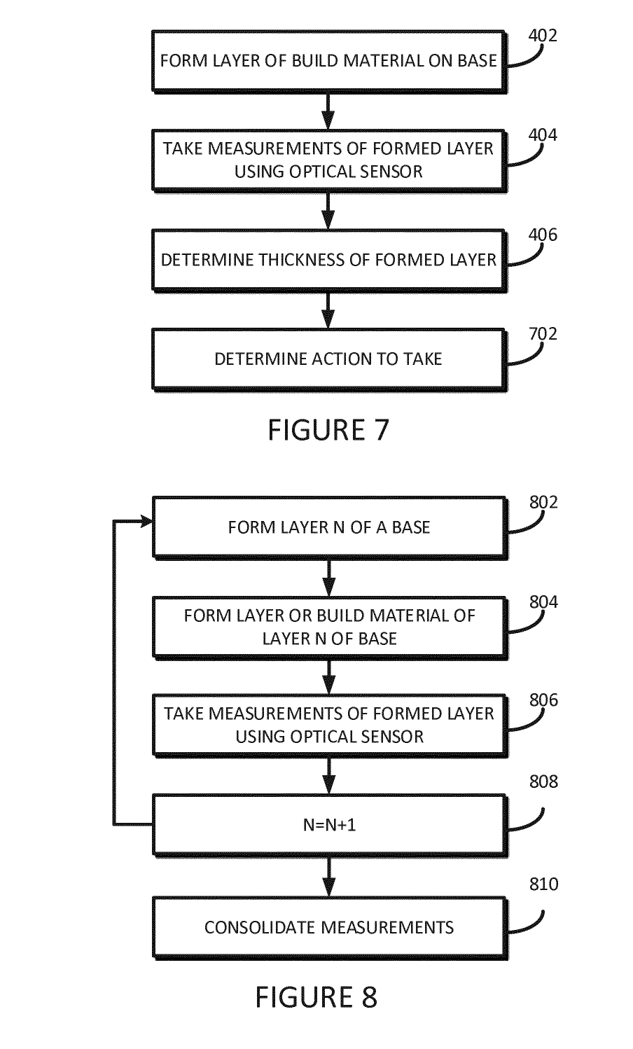

FIG. 7 is a flow diagram outlining an example method according to one example; and

FIG. 8 is a flow diagram outlining an example method according to one example.

### DETAILED DESCRIPTION

Some 3D printing systems use build material that has a powdered, or granular, form. According to one example a suitable build material may be a powdered semi-crystalline thermoplastic material. One suitable material may be Nylon 12, which is available, for example, from Sigma-Aldrich Co. LLC. Another suitable material may be PA 2200 which is available from Electro Optical Systems EOS GmbH.

In other examples other suitable build materials may be used. Such materials may include, for example, powdered metal materials, powdered plastics materials, powdered composite materials, powdered ceramic materials, powdered glass materials, powdered resin material, powdered polymer materials, and the like. Different powders may have different characteristics, such as different average particle sizes, different minimum and maximum particle sizes, different coefficients of friction, different angles of repose, and the like. In some examples non-powdered build materials may be used, such as gels, pastes, and slurries.

Such 3D printing systems typically provide, along a side of a build platform, a quantity of build material to be spread over the build platform to form a thin layer of build material on the build platform. Portions of the layer of build material may then be solidified, using any suitable solidification technique or any build material solidification sub-system, such as fusing agent deposition and heating systems, binder agent deposition systems, laser sintering systems, and the like.

In some 3D printing systems each layer of build material formed on the build platform may be in the region of about 100 microns thick, meaning that each 1 mm of generated object may be formed from between about 10 to 20 layers, depending on the particular build material solidification techniques used and the degree of contraction the build material undergoes. Consequently, as a generated object may be formed from a large number of layers of build material the uniformity of the thickness of each layer of build material formed on the build platform is a factor in generating high quality objects.

During a 3D printing operation, an initial layer of build material may be spread directly on the surface of a build platform, whereas subsequent layers of build material may be formed on a previously formed layer of build material. Herein, reference to forming a layer of build material on the build platform may refer, depending on the context, either to forming a layer of build material directly on the surface of the build platform, or to forming a layer of build material on a previously formed layer of build material.

Referring now to FIG. 1a there is shown a side view illustration of a portion of a 3D printing system 100 according to one example. FIG. 1b shows a corresponding top view illustration of the system 100. For clarity reasons not all the elements of the 3D printing system 100 are shown.

The system 100 comprises a build module 102 in which a 3D object may be generated by the system 100. In one example the build module 102 may be removable. The build module 102 comprises a movable build platform 104 which is movable vertically, in the z-axis, to enable the height of the build platform 104 to be precisely controlled. For example, the build platform 104 may be controllable to be lowered by a small amount, such as around 100 microns, to enable a layer of build material to be formed thereon.

Adjacent to a first side of the build module 102 there is provided a first build material support 106, and adjacent to a second side of the build module 102 there is provided a second build material support 108. In one example the first and second build material supports 106 and 108 are located on opposite sides of the build module 102, when the build module 102 is present. The system 100 may comprise a suitable interface (not shown) to receive the build module 102 and to allow the build module 102 to be removed.

The system 100 further comprises a build material distributor 110 to selectively form a quantity of build material 112 onto the first build material support 106 at a build material distribution zone 114. In the example shown the build material distributor 110 is positioned generally vertically above the distribution zone 114, although in other examples the build material distributor 110 may be positioned in other appropriate positions. In other examples, the build material distributor may take other forms, and may, for example, be positioned below build material support 106 and may form a quantity of build material on the build material support 106 in any appropriate manner. In one example the build material 112 is stored within the build material distributor 110. In other examples at least a portion of the build material 112 may be stored in a separate build material store (not shown).

In the example shown, the build material distributor 110 is controllable to form a pile of build material in the distribution zone 114. The quantity of build material deposited from the build material distributor 110 may be controllable using a suitable valve, such as a rotary valve (not shown). Although not visible in FIG. 1b, in one example the build material distributor 110 has a build material output that, in one example, has about the same length (in the y-axis) as the build platform 104. This allows the build material distributor 110 to form a pile of build material along the length (y-axis) of the build material support 106. In another example, the build material distributor 110 could be movable, in the y-axis, across the build material support 106 to enable a pile of build material to be formed along the length (in the y-axis) of the build support 106.

In one example the build material distributor 110 forms a pile of build material that has a substantially uniform cross-section along its length.

The system 100 also comprises a build material spreader 116 to move or spread the pile of build material across the build platform 104 to form a layer of build material thereon. In one example the build material spreader 116 is a roller, although in other examples other suitable spreader mechanisms, such as a wiper blade, may be used.

The build material spreader 116 is movable bi-directionally, in the x-axis, along the first build material support 106, over the build platform 104, and along the second build material support 108. The build material spreader 116 may be mounted on a movable carriage, gantry, or other suitable mechanism. The spreader 116 has a first vertical operational height where the spreader 116 may rest on, or contact, one of the build material supports 106 and 108.

If the build material spreader 116 is in direct contact with a surface it will move build material along that surface, and leave no, or very little, build material behind the spreader. If, however, the build material spreader 116 is not in direct contact with a surface it will spread build material along that surface and form a layer of build material that has a thickness equivalent to the height of the base of the spreader 116 above that surface. When spreading, the build material spreader 116 may also move a quantity of excess build material that is not spread.

The system 100 further comprises an agent distributor 118 to distribute one or multiple agents on a layer of build material formed on the build platform 104. In one example the agent distributor 118 comprises one or multiple printheads. In one example the printhead or printheads are arranged in a page-wide array configuration such that they span substantially the length (y-axis) of the build platform 104. In this way, a pattern of the one or multiple types of agents may be printed, or otherwise deposited, on a formed layer of build material in a single pass along the x-axis. In another example, a scanning printhead configuration may be used, for example, where one or multiple printheads are scanned one or multiple times across the length (y-axis) of the build platform 104 to print, or deposit, a swath of the one or multiple types of agents on the formed layer of build material. The printheads may then be advanced along the x-axis to allow further swaths to be printed. The agent distributor 118 is controlled based on print data that defines the locations within each formed layer of build material at which agent is to be distributed.

In the example shown, the agent distributor 118 and the spreader 116 may be mounted on a suitable carriage or gantry to enable them to be controllably moved over the build platform 104. In one example, the agent distributor 118 and the spreader 116 are mounted on the same carriage or gantry. In another example, the agent distributor 118 may be mounted on a first carriage or gantry, and the spreader 116 may be mounted on a separate carriage or gantry (not shown). In one example the agent distributor 118 and spreader 116 are movable along the same axis. In another example the agent distributor 118 and spreader 116 are movable along different axes, such as along orthogonal axes.

In one example the agent distributor 118 may distribute a fusing, or coalescing agent. In one non-limiting example, a suitable fusing agent may be an ink-type formulation comprising carbon black, such as, for example, the ink formulation commercially known as CM997A available from Hewlett-Packard Company. In one example such an ink may additionally comprise an infra-red light absorber. In one example such an ink may additionally comprise a near infra-red light absorber. In one example such an ink may additionally comprise a visible light absorber. Examples of inks comprising visible light enhancers are dye based colored ink and pigment based colored ink, such as inks commercially known as CE039A and CE042A available from Hewlett-Packard Company.

The printing system 100 also comprises an electromagnetic energy source 120. In one example, the energy source may be a heating lamp. The energy source 120 is used to apply energy to build material on the build platform 104 to cause portions of the build material on which a fusing agent has been deposited to absorb energy, to heat up, and to coalesce or fuse, and subsequently solidify.

The type of energy source used may depend on one or more of: characteristics of the build material; and characteristics of the fusing agent. In one example the system 100 is configured to apply energy for predetermined length of time.

In one example the energy source 120 may be selected to apply infrared or near infra-red energy, although in other examples the energy source 120 may be selected to apply other types of energy, such as microwave energy, ultra-violet (UV) light, halogen light, ultra-sonic energy or the like. The length of time the energy is applied for, or energy exposure time, may be dependent, for example, characteristics that may include on one or more of: characteristics of the energy source; characteristics of the build material; characteristics of the fusing agent; and the temperature of the build material.

The temporary application of energy causes portions of the build material on which fusing agent has been delivered or has penetrated to heat up above the melting point of the build material and to coalesce. Upon cooling, the portions which have coalesced become solid, or fused, and form part of the three-dimensional object being generated.

In one example the build material is generally of a white color and has known, or determinable, color characteristics. In one example the fusing agent is generally of a black color and has known, or determinable, color characteristics.

The system 100 further comprises an optical sensor 122. The optical sensor may be coupled to one of the agent distributor 118 and the spreader 116, or may in other examples be independent thereof. The optical sensor 122 comprises a light emitter (not shown) and a light receiver (not shown) both oriented generally downwards. In operation, the optical sensor 122 is controllable to emit light onto the surface of a layer of build material formed on the build platform 104, and to measure the amount of light reflected from a formed layer of build material. In one example the optical sensor light source is a light emitting diode (LED), and the light sensor receiver is a photo diode. Such components are readily available at low cost. In other examples, however, other suitable optical sensors may be used.

The optical sensor 122 may be controlled to take optical measurements from the surface of a formed layer of build material at one or multiple locations on the platform.

In one example, the optical sensor 122 may comprise a single light emitter and a single light receiver, although in other examples the optical sensor 122 may comprise an array of multiple light emitters and corresponding light receivers.

Operation of the system 100 and different elements thereof is generally controlled by a controller 124. The controller 124 is illustrated in more detail in FIG. 2. The controller 124 comprises a processor 202 coupled to a memory 204. The memory 204 stores build material layer thickness control instructions 206 that, when executed by the processor 202, control the system 100 to determine the thickness of a formed layer of build material, as described further below.

Example operation of the 3D printing system 100 will now be described with reference to the flow diagram of FIG. 3 and with additional reference to FIGS. 4, 5 and 6.

Referring now to FIG. 3, at block 402 the controller 124 controls elements of the printing system 100 to form a layer of build material 402 on a base 400. In one example, this may comprise the controller 124 controlling the build platform 104 to be positioned about 100 microns below the upper surface of the build material support 106, controlling the build material distributor 110 to deposit a quantity of build material in the build material deposition zone 114, and controlling the build material spreader 116 to form a layer of build material on the build platform 104.

In one example, the base 400 on which the layer of build material is formed is a base comprising a set of previously formed layers of build material of which selected portions thereof have been solidified, in the manner described above, in accordance with a set of predetermined patterns.

In one example, as shown in the side view illustrated of FIG. 4, the controller 124 controls elements of the printing system 100 to form a base 400 by forming a layer 400a of build material, to print fusing agent on the layer 400a in accordance with a first pattern, and to apply fusing energy to solidify portions of the layer of build material where fusing agent was printed. The controller 124 then controls elements of the printing system 100 to form a further layer of build material atop the previously processed layer, to apply fusing agent to the formed layer in accordance with a second pattern, and to apply fusing energy. This may be repeated multiple times, for example using a different pattern for the fusing agent in each layer, until a desired base has been formed.

In one example, as illustrated in FIG. 4, the base 400 comprises 5 layers of build material 400a to 400e, and the patterns of fusing agent cause the formation of a set of steps of solidified build material. Build material 404 remains unsolidified where no fusing agent was printed. In one example the base 400 may be formed directly on the surface of the build platform 104, although in other examples the base 400 may be formed on previously formed layers of build material.

In the present example, the solidified portions of build material have known color characteristics based substantially on the color characteristics of the fusing agent, and the unsolidified build material has known color characteristics based on the color characteristics of the build material.

FIG. 5 shows a top view illustration of the layer 402 of build material formed on top of the base 400. Due to the thinness of the layer of build material, the layer of build material is not opaque, and hence the observed color of the layer 402 of build material depends on the color of the layers below. Accordingly, a portion 502a, formed on four layers of unsolidified build material may be observed to have substantially the color of the build material. A portion 502f, on the other hand, formed on four layers of solidified build material may be observed to have a color close to the color of the fusing agent. Portions 502b to 502e may be observed to have respective colors intermediate the colors of portions 502a and 502f, as illustrated in FIG. 5. It will be appreciated that the difference in contrast between the portions 502a and 502f are illustrative only for the purpose of explanation, and may not represent actual color differences observed.

At block 404 the controller 124 controls optical sensor 122 to take measurements from the surface of the layer 402 of build material. In one example the controller 124 controls the optical sensor 122 to move over the build module 102 in the x-axis, to allow measurements to be taken at multiple locations from the surface of the layer 402. In one example measurements may be taken continuously, although in other examples measurements may be taken at discrete locations.

The measurements may not cover the entire surface of the layer 402, but are sufficient to be representative of overall thickness of the surface of the layer 402.

In one example, the measurements taken are electrical measurements that represent the amount of light emitted by the light source and reflected off the layer 402 and received at the light receiver. If the light receiver is a photo diode, the output of the photo diode will be an electrical voltage that is directly proportional to the amount of reflected light received, as illustrated in FIG. 6. The signal 602 shows the difference in voltage based on the observed color of the surface of the layer 402.

At block 406, the controller 124 determines, based on the measurements, the thickness of the layer 402 of build material. In one example, in the memory 204 of the controller 124 is stored reference data that defines the relationship of the electrical signal generated by the light receiver and the known thickness of a layer of build material. This data may have been stored during manufacture, for example as a result of a measurement process performed under controlled conditions. By comparing the measured voltages with the reference data the controller 124, and taking into account the base 400 on which the layer 402 of build material is formed, the controller 124 can determine the thickness of the layer 402 where the measurement was taken.

In this way, the controller 124 effectively compares the determined color characteristic of a portion of a formed layer of build material with a reference color characteristic, the reference color characteristic being based on characteristics of the base, or underlying layers, on which the portion of the formed layer of build material is formed. The thickness of the portion of the formed layer of build material may be determined by the comparison.

For example, the controller 124 knows that the portion of the signal 602 that corresponds to portion 502a was measured on a portion of the layer 402 that was formed on five layers of unsolidified build material. Accordingly, the controller 124, can determine an amount of deviation, if any, between the measured portion of the signal and the corresponding reference data.

Similarly, the controller 124 knows that the portion of the signal 602 that corresponds to portion 502f was measured on a portion of the layer 402 that was formed on five layers of solidified build material. Accordingly, the controller 124, can determine an amount of deviation, if any, between the measured portion of the signal and the corresponding reference data.

The controller 124 may determine an amount of thickness deviation at each point at which the signal 602 was measured.

In other examples other patterns of fusing agent can be distributed to generate a base 400 having different characteristics.

In another example, the base on which the layer of build material is formed is the upper surface of the build platform 104 which has had a predetermined colored pattern formed thereon or fixed thereto. For example the build platform 104 may have a predetermined set of colors printed or formed thereon.

In a further example, as shown in FIG. 7, at block 702, the controller 124 determines an action to take in response to having determined the thickness of the layer 402. For example, if the controller 124 determines that the determined thickness is within acceptable tolerances, the controller 124 may indicate this to a user, for example through a suitable user interface, or may allow a 3D object to be generated by the system 100.

If, however, the controller 124 determines that the determined thickness is outside of acceptable tolerances it may indicate this to a user, for example through a suitable user interface, and may prevent a 3D object from being generated by the system 100. In a further example, the controller 124 may determine a corrective action to perform. A corrective action may include adjusting operating parameters of the system 100 such that subsequently formed layers of build material have a layer thickness within acceptable tolerances. Such corrective actions may include: calibrating the amount by which the build platform 104 is moved when a new layer of build material is to be formed thereon; adjusting an amount of fusing agent deposited on portions of the build material that are to be solidified; modifying the amount of energy applied during a fusing stage; and modifying temperature characteristics of the system 100 to control the degree of contraction of fused build material.

In one example the base may comprise just a single layer, and a base may comprise multiple layers of a base.

In a further example, as shown in FIG. 8, measurements of each formed layer of build material may be taken during the formation of the base. For example, at block 802 the controller 124 controls elements of the printing system 100 to form a first layer n of a base by forming a layer of build material, to print fusing agent on the layer in accordance with a first pattern, and to apply fusing energy to solidify portions of the layer of build material where fusing agent was printed.

At block 804 the controller 124 then controls elements of the printing system 100 to form a further layer of build material atop the previously processed layer.

At block 806 the controller 124 then controls the optical sensor 122 to take measurements of from the surface of the formed layer of build material.

At block 808 the controller 124 then controls elements of the printing system 100 to form a layer N+1 of the base until a desired number of layers of the base have been formed.

At block 810 the controller 124 processes the measurements obtained as the base was formed to generate consolidated layer thickness measurements.

Using this method enables the controller 124 to measure the thickness of a formed layer multiple times, at multiple locations, at over multiple depths of previously formed layers. For example, if the base generated during this method has the stepped shape illustrated in FIG. 4, then after the controller 124 has caused layer 400b to be generated, optical measurements will be taken from the layer of formed build material of layer 400c. This layer will have a portion that is directly formed on a solidified portion of layer 400b, a portion that is formed on an unsolidified portion of layer 400b that has the thickness of layer 400c, and a portion that is formed on an unsolidified portion of layers 400b and 400c. Accordingly, during the formation of the base the controller may determine multiple thickness measurements based on optical measurements taken from a formed layer of build material formed on different thickness of unsolidified build material.

This may be useful, for example, to help identify periodic errors in elements of the printing system 100, for example due to gear eccentricity, and the like.

In one example the base may be any processed layer of build material, for example a layer of build material processed during the generation of a 3D object.

In a yet further example, the controller 124 may, at block 402, form the layer of build material on a base that comprises a 3D object that has just been generated by the system 100. For example, if multiple objects are to be generated within the build module 102, the controller 124 may perform the layer thickness measurement process described herein between the generation of two objects.

The build material layer thickness measurement system described herein enables accurate measurements to be determined, since the measurements are made, and the layer thickness determined, whilst the system 100 is operating under real operating conditions.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine readable storage storing such a program. Still further, some examples may be conveyed electronically via any medium such as a communication signal carried over a wired or wireless connection.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A method, in a three-dimensional printing system of determining the thickness of a layer of build material formed on a build platform, comprising:
forming a layer of build material on a base having predetermined color characteristics;
optically measuring color characteristics of the deposited layer of build material; and
determining, based on the measured color characteristics, the thickness of at least a portion of the formed layer of build material.

2. The method of claim 1, wherein forming a layer on a base comprises forming a layer of build material on a base comprising at least one previously formed layer of build material.

3. The method of claim 2, further comprising forming each layer of the base by:
forming a layer of build material on a build platform;
depositing a pattern of colored fusing agent on the formed layer of build material; and
applying fusing energy to the formed layer of build material to solidify those portions on which fusing agent was deposited.

4. The method of claim 3, further comprising depositing a different pattern of colored fusing agent on each formed layer of build material.

5. The method of claim 1, wherein determining the thickness of the formed layer of build material comprises determining a thickness profile of the layer at multiple locations of the layer.

6. The method of claim 1, wherein determining the thickness of the formed layer of build material comprises comparing the measured color characteristics with a set a reference characteristics and determining from the comparison the thickness of the layer of build material

7. The method of claim 1, wherein optically measuring optically measuring color characteristics of a deposited layer of build material and determining, based on the measured color characteristics, the thickness of the formed layer of build material are performed after each layer of the base is generated.

8. The method of claim 1, further comprising, where it is determined that the thickness of the formed layer of build material is not with a predetermined tolerance, taking a remedial action that includes one of: reforming the layer of build material; determining printing system calibration data; and triggering an alert.

9. A three-dimensional printing system comprising:
a removable build platform;
a build material distributor;
a build material spreader;
an optical sensor; and
a controller to:
form, using the build material distributor and the build material spreader, a layer of build material on predetermined base;
take, using the optical sensor, optical measurements from the surface of the formed layer of build material; and
determine, from the optical measurements, a thickness of a portion of the formed layer of build layer.

10. The three-dimensional printing system of claim 9, wherein the controller is to perform, where the determined thickness is not within an acceptable tolerance, a remedial action that includes one of: reforming the layer of build material; determining and applying printing system calibration data; and triggering an alert through a user interface.

11. The three-dimensional printing system of claim 9, wherein the controller is to form the base from a plurality of layers of build material, and wherein the controller is further take optical measurements from a formed layer of build material as each layer of the base is formed.

12. The three-dimensional printing system of claim 11, wherein the controller takes optical measurements at multiple locations of each formed layer of build material.

13. The three-dimensional printing system of claim 9, wherein the controller forms each layer of the base by:
controlling the build material distributor and build material spreader to form a layer of build material; and
controlling a build material solidification sub-system to solidify portions of the formed layer of build material in accordance with a predetermined pattern.

14. The three-dimensional printing system of claim 9, wherein the base is part of the build platform and comprises a predetermined pattern having predetermined color characteristics.

15. A computer readable medium storing instructions that, when executed by a controller, cause the controller of a three-dimensional printing system to:
form a layer of build material on a predetermined base having predetermined characteristics;
determine a color characteristic of a portion of the formed layer of build material of which the thickness is to be determined;
compare the determined color characteristic with a reference color characteristic, the reference color characteristic based on characteristics of the base on which the portion of the formed layer of build material is formed; and
determine, by the comparison, the thickness the portion of the formed layer of build material.
